(19) United States
(12) Patent Application Publication
(10) Pub. No.: US 2005/0085972 A1
(43) Pub. Date: Apr. 21, 2005

(54) Door opening limit control system

(75) Inventor: Anthony Edward Martinez, St. Augustine, FL (US)

Correspondence Address: Robert V. Wilder;Attorney at Law, 4235 Kingsburg Drive, Round Rock, TX, 78681, US

(73) Assignee: International Business Machines Corporation, Armonk, NY (US)

(21) Appl. No.: 10/687,249

(22) Filed: Oct. 16, 2003

(51) Int. Cl. G06F 17/00

(52) U.S. Cl. 701/49; 307/10.1

(57) ABSTRACT

A method and implementing computerized system are provided for enabling the setting of automatic door opening limits for doors. In an exemplary embodiment, distance measuring transceivers, such as radar devices, are implemented in the doors of a vehicle to determine the distance between a vehicle door and nearby obstacles which may obstruct the full opening of the door. If the measured obstacle distance is less than the predetermined clearance distance required for a full opening of the door, then the maximum allowable distance for the door to open without encountering the obstacle is determined and limits are set to prevent the vehicle door from opening more widely than the maximum allowable distance. In one embodiment, the door opening is restricted by mechanical limits which are established by a gear-driven or rack-and-pinion system controlled by a limit control motor. The limit control motor is operable to position a mechanical door opening limiting apparatus in response to the measured obstacle distance to physically limit the extent to which the door is allowed to open. Visual and audio signals are also provided to communicate related messages to the driver and/or passengers of the vehicle. In one embodiment, the system may be disabled when an emergency situation is detected such as when the vehicle air bags are deployed.

### FIELD OF THE INVENTION

The present invention relates generally to information processing systems and more particularly to a methodology and implementation for enabling automatic control of opening limits for doors.

### BACKGROUND OF THE INVENTION

As the number of passenger and other vehicles on the road continues to increase, along with the number of new office and other commercial buildings, so does the number of parking lots required to accommodate such vehicles. Further, in order to accommodate more vehicles, the individual parking spaces are becoming smaller and closer together. In many parking garages, individual parking spaces are positioned directly adjacent to a structural wall. All of these developments have created an environment in which it is very difficult to park a vehicle in a tight space and open one or more doors without having the door strike a another vehicle or another obstacle such as a structural wall or fence, and damaging the door of the vehicle. Often an obstacle in the swing path of an opening door is not entirely visible from the vehicle especially obstacles which are below the window level of the vehicle. Further, many times, even when there is some space to open a door, there is insufficient space to open the door of a vehicle enough to allow a person to safely exit or enter the vehicle. Past temporary solutions to this problem, such as plastic clips at door edges, have been ineffective and/or unsightly, and have not provided an acceptable long-term solution.

Thus, there is a need for an improved methodology and system for enabling automatic control of opening limits for doors and the like.

### SUMMARY OF THE INVENTION

A method and implementing computerized system are provided for enabling the setting of automatic door opening limits for doors. In an exemplary embodiment, distance measuring transceivers are implemented in a swingable door to determine the distance between the door and nearby obstacles which may obstruct the full opening of the door. If the measured obstacle distance is less than the predetermined clearance distance required for a full opening of the door, then the maximum allowable distance for the door to open without encountering the obstacle is determined and limits are set to prevent the door from opening more widely than the maximum allowable distance. In one embodiment, the door opening is restricted by mechanical limits which are established by a gear-driven or rack-and-pinion system controlled by a limit control motor. The limit control motor is operable to position a mechanical door opening limiting apparatus in response to the measured obstacle distance to physically limit the extent to which the door is allowed to open. In another embodiment, the door opening limits may be overcome by exerting additional door opening force after an initial limit is encountered. Visual and audio signals are also generated to provide perceivable messages relating to a detection of an obstacle.

### BRIEF DESCRIPTION OF THE DRAWINGS

A better understanding of the present invention can be obtained when the following detailed description of a preferred embodiment is considered in conjunction with the following drawings, in which:

FIG. 1 is an illustration showing an exemplary environment in which the present invention may be used;

FIG. 2 is an illustration showing signals being transmitted from a vehicle to help determine distance to a nearby obstacle;

FIG. 3 illustrates return signals being received by the vehicle and transmitted to a control system onboard the vehicle;

FIG. 4 illustrates an exemplary embodiment of a control device and related display and audio systems onboard the vehicle;

FIG. 5 illustrates an exemplary embodiment of a limit control apparatus onboard the vehicle for controlling the limit to which a vehicle door may be opened;

FIG. 6 illustrates an exemplary operation using the limit control apparatus of FIG. 5;

FIGS. 7A-7D are illustrations showing an exemplary operation of an alternate embodiment of the present invention; and

FIG. 8 is a flow chart illustrating a high level operational flow in an exemplary implementation of the present invention.

### DETAILED DESCRIPTION

It is noted that circuits and devices which are shown in block form in the drawings are generally known to those skilled in the art, and are not specified to any greater extent than that considered necessary as illustrated, for the understanding and appreciation of the underlying concepts of the present invention and in order not to obfuscate or distract from the teachings of the present invention.

An illustrated embodiment of the present invention uses a computerized control module, door swing-controlling servomechanisms and commercially available radar (“Back Radar”) or sonar (“Sonar Vision”, “SafeReverse Sonar”) transceivers. Radar or sonar transceivers are used in the present example although it is understood that other distance measuring sensor devices may also be used. In the present disclosure, the terms “radar” and “sonar” are used interchangeably to refer generally to distance measuring devices. The radar or sonar units are mounted are mounted near the outer edge of the vehicle doors and they are used to scan for possible obstructions in each door's swing path. Return signals are sent to a module which controls a limit mechanism for each door. The limit mechanisms may be set to selectively or continually adjust themselves to set a maximum allowable door opening limit for each door thus freeing the occupants of the vehicle from worrying about how far to open a door when entering or leaving a vehicle.

The system can also be manually overridden for emergency situations or when an obstruction is lightweight or pliable or movable, i.e. foliage. In one embodiment, the opening limit may be overcome and bypassed by asserting an increased amount of force after the initial resistance of the opening limit has been reached. This bypass function may be useful in situations where a bush or similar plant or other pliable obstacle has caused an initial limit to be set. A user may then overcome the initial limit by exerting additional force to open the door farther beyond the initial limit into a detected bush in order to exit the vehicle in an emergency for example.

The radar or sonar sensors working with the control module also alert the occupants visibly and/or audibly on a per-door basis when the door is blocked from opening or when an opening is too narrow for safe usage. This gives the driver advance warning to adjust the car's position, i.e. re-park the vehicle, while the car is still in motion.

The example used herein to illustrate an operation of the present invention includes a vehicle but it is noted that the invention has many other applications as well, including sliding doors and overhead doors running on tracks. For example, the present invention may be used for sliding and other intelligent opening-controlled doors on factory floors and hospitals to reduce accidents and personal injuries.

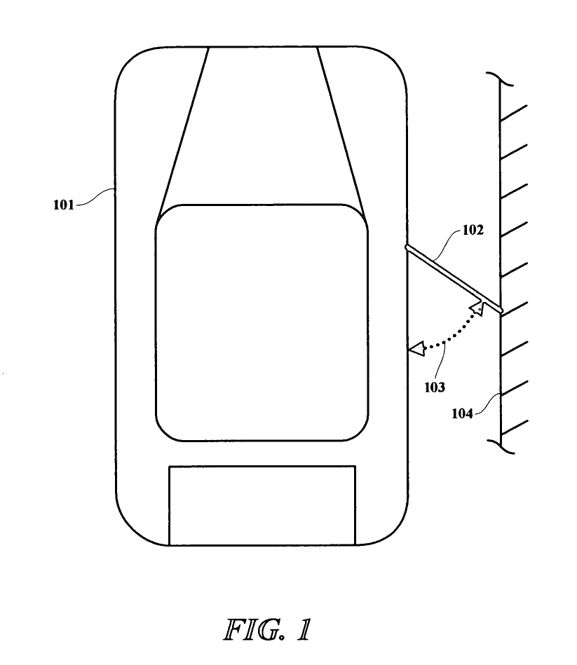

In FIG. 1, there is shown a motor vehicle 101 including a door 102 which may be opened as shown 103 into an obstacle or non-movable object such as a wall 104. This is a common scene for example in a parking garage when a door is opened into a wall and causes an indentation on the car door 102.

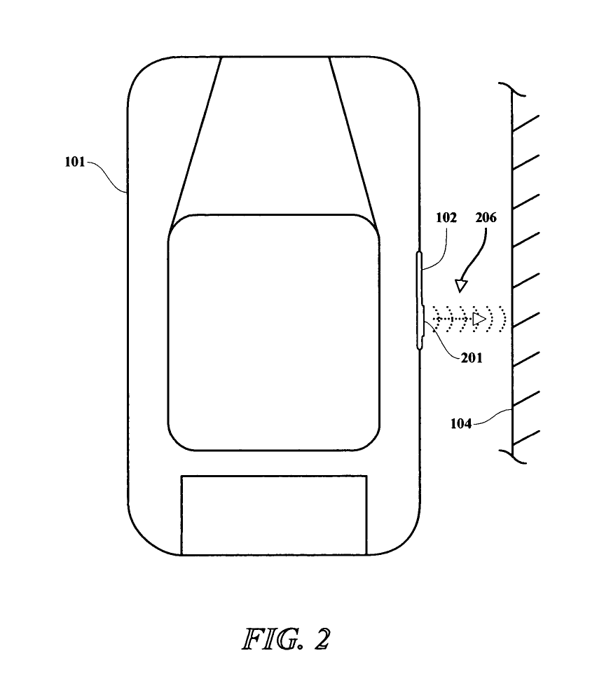

As shown in FIG. 2, the vehicle door 102 is in a closed position and a radar or sonar transceiver or sensor 201 is mounted near the edge of the car door 102. In the Figure, a radar or sonar signal is being transmitted outwardly 206 from the door 102 toward the obstacle 104.

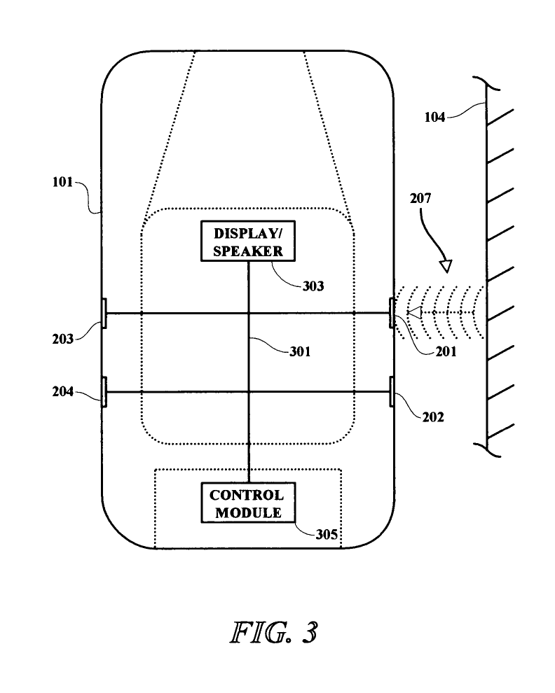

FIG. 3 shows the radar or sonar signal being reflected 207 by the obstacle 104 back to the sensor 201 mounted on the vehicle door (not shown). The reflected signal 207 is indicative of the distance between the transceiver 201 and the obstacle 104. This signal is received by the sensor 201 and transmitted along an internal bus 301. The bus 301 is connected to other sensors 202, 203, and 204 on the other doors of the vehicle. The bus 301 is also connected to a speaker/display system 303 to communicate with the occupants of the vehicle. If a reflected signal indicates that an obstruction is too close to open a door safely, a prerecorded message may be played on the audio system and a symbol representative of which of the four doors is obstructed may be flashed or otherwise displayed on the display device 303. For example, after sensing that the vehicle is too close to a wall to open a door safely, a prerecorded audio message may play stating that “The right front door cannot be opened safely at the present position.”

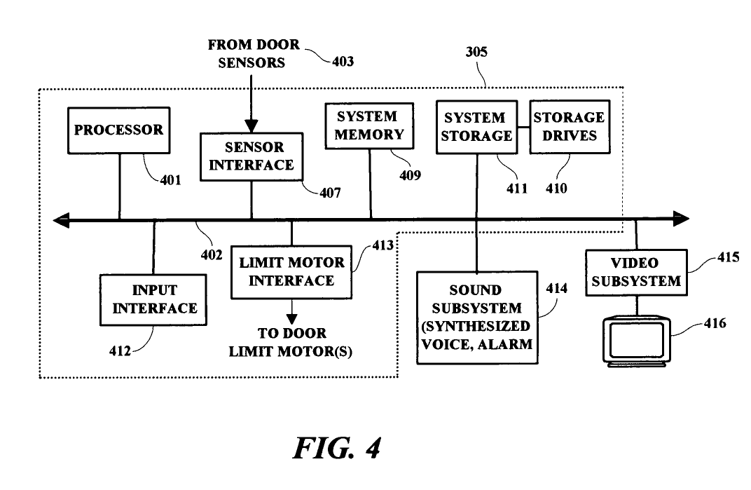

FIG. 4 illustrates an exemplary embodiment of the control module 305. As shown, the module 305 includes a processor 401 which is connected to a system bus 402. The module 305 receives input 403 from the sensors or transceivers 201-204 which are applied to a sensor interface 407. The sensor interface is connected to the system bus 402. The system bus 402 is also connected to system memory 409, system storage 411 and an input interface 412. The input interface 412 may be used to input designated commands from a driver of the vehicle, either by voice commands or push-button/toggle switch input (not shown) in order to activate and/or de-activate the system, for example. System storage includes programming and databases which are useful in ascertaining maximum allowable door openings and other information for various vehicles. Storage drives 410, including but not limited to hard drives and CD drives, are also included to enable updating and customizing programming and vehicle data. The system bus 402 is also connected to limit motor interface circuitry 413 which provides output signals to door limit motors for controlling opening limits for the doors of the vehicle. The sound subsystem 414 is also connected to the system bus and may include a synthesized voice capability as well as various alarms which may be used in connection with the present invention. A video subsystem 415 and display device 416 are also shown connected to the system bus 402. The video system 415, 416 and the sound or audio system 414 are shown in an exemplary location 303 within the vehicle in FIG. 3.

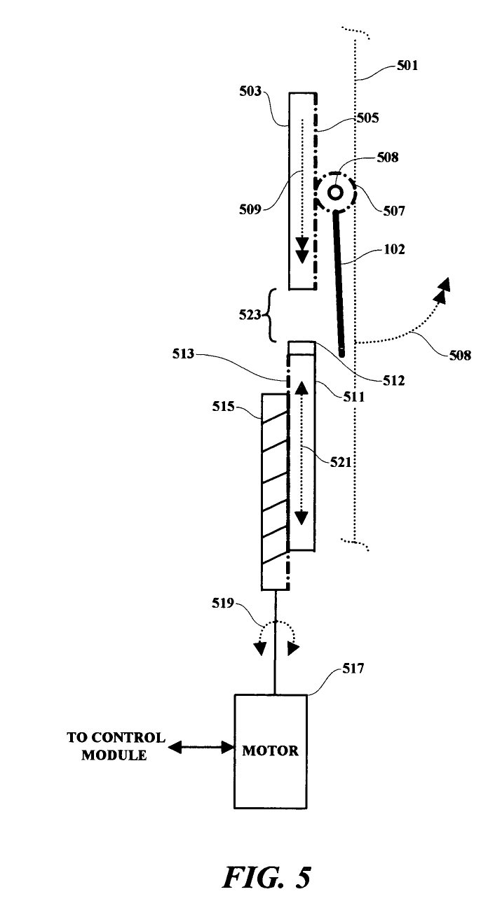

FIG. 5 illustrates an exemplary embodiment of a limit control apparatus which may be used in connection with the present invention. Dashed line 501 is used to schematically indicate the right side vehicle line in the example. The door 102 is illustrated in a closed position and may be opened 508 as shown to allow passengers to enter and exit the vehicle. A door limit control motor 517 receives input from the control module 305 shown in FIG. 4. In response to door limit signals received from the control module 305, the motor is operable to rotate 519 a positioning element 515. The positioning screw-drive element rotates in place and engages with teeth 513 on a limit element 511 to move the limit element 511 in either direction 521 as illustrated, to a position determined by the control module output signals.

When the vehicle door 102 is opened 508, a hinge assembly rotates around axis 508 and, through a rack and pinion or gearing arrangement 505, 507, moves a door position indicator element 503 toward the limit element 511 as shown 509. A bumper 512 is placed at the end of the limit element 511 to provide a mechanical buffer between the limit element 511 and the door position indicator element 503. When the door 102 is in the open position, the relationship of the gearing arrangements is such that there is unobstructed space 523 between the position element 503 and the limit element 511 so the position element may move freely toward the limit element 511.

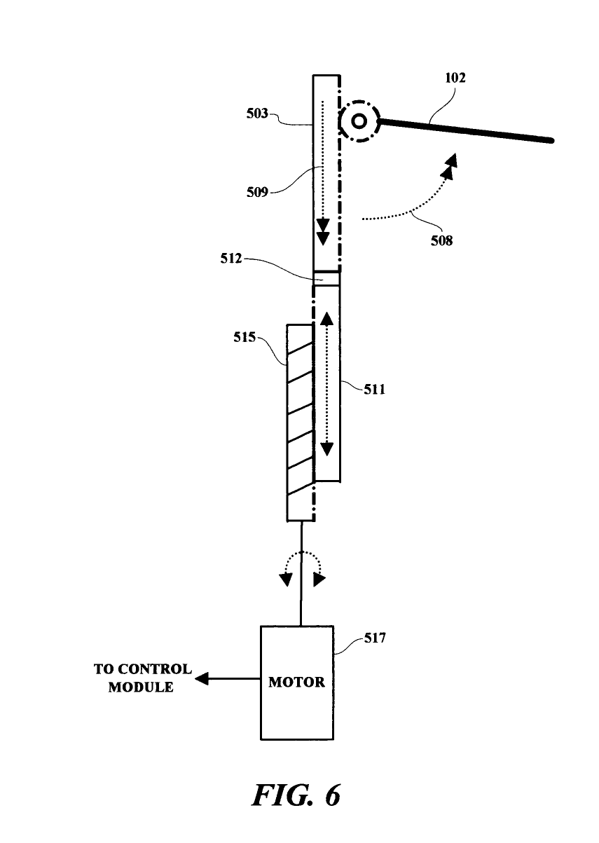

However, as shown in FIG. 6, when the door 102 has moved 508 and reached its outer limit of travel, the position element 503 comes into full abutment with the limit element 515 and the door 102 is unable to open any farther. Thus, when an obstruction is detected by the sensors mounted on the door of a vehicle, the maximum allowable distance that a door may open without encountering the obstruction is calculated or determined by the control module 305 and signals representative of that allowable distance are sent to the appropriate door limit motor which in turn rotates to move and set the corresponding door limit element 515 in a position so that the door 102 is physically prevented from opening more than the maximum allowable distance.

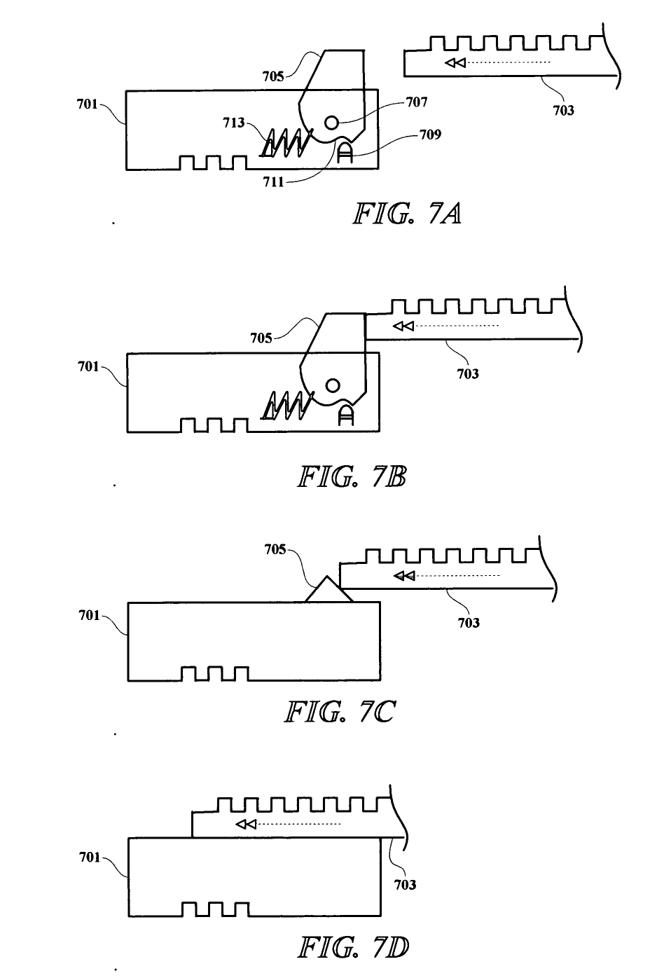

FIGS. 7A-7D show an exemplary operation of the limiting function in an alternate embodiment. As shown, limiting element 701 corresponds to limit element 511 in FIG. 5 and door position element or slider bar 703 corresponds to position element 503 in FIG. 5 and is coupled to a door. In FIG. 7A, limit element 701 includes a hinged stopper 705 which serves to provide an initial stop for the slider bar 703 as a door is opened and the slider bar 703 moves to the left as shown in FIG. 7B. A spring-released pin 709 is spring biased upwardly and also electromagnetically locked into the up position to engage with a corresponding slot 711 in the hinged stopper 705 thereby locking the hinged stopper 705 in place. The hinged stopper 705 is held in the position shown in FIG. 7A by a hinged stopper return spring 713. As shown in FIGS. 7B-7D, as a vehicle door for example, is opened with a normal force, the position element 703 will move to the left and the door position element or slider bar 703 will be stopped when it encounters the hinged stopper 705 (FIG. 7B) at the calculated allowable limit for the door opening. Thereafter, if the electromagnet (not shown) holding the pin 709 in the up position is de-energized, (which may be done either selectively by a user or automatically when an emergency condition is present), the pin 709 is still biased in the up position but only by the force of the pin-biasing spring (not shown). Thereafter, if additional force is exerted in opening the door, the slider bar will overcome the holding force exerted on it by the hinged stopper 705, the hinged stopper will be forced to rotate counterclockwise overcoming the spring bias holding the pin 709 in the slot or recess 711, and the hinged stopper will rotate completely out of the way as additional force is exerted in opening the door causing the door position slider bar to move farther to the left and beyond its allowable limit as shown in FIG. 7D.

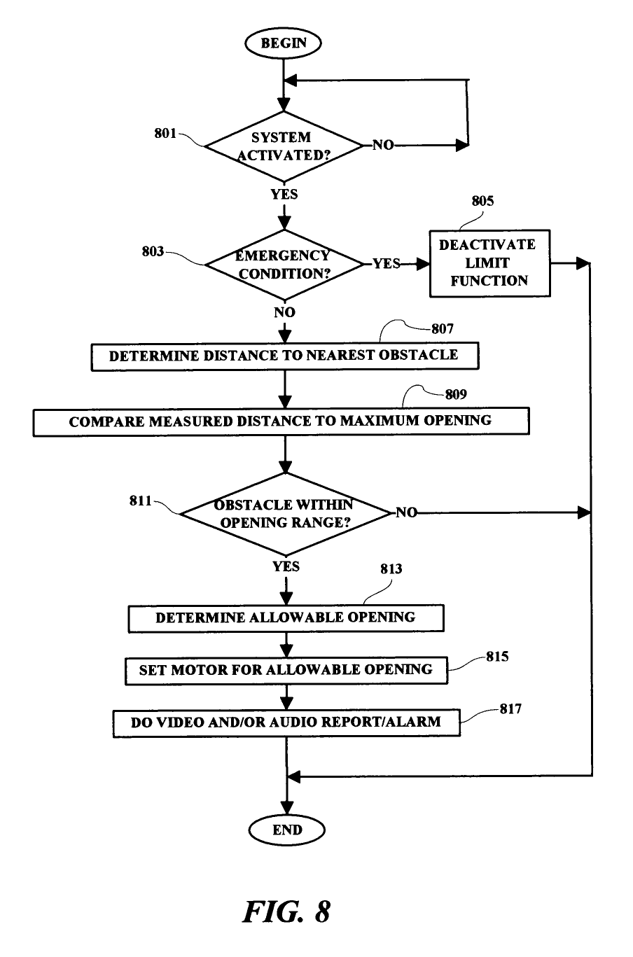

In FIG. 8, the overall operational methodology begins by determining that the limit controlling system has been activated 801. The system may be set to continually measure and report on obstructions near a vehicle door and in this mode, an alarm may be sounded, even while traveling, if an obstacle or vehicle is determined to be too close to the side of the vehicle. This will enable a driver to take evasive action for example to avoid a side collision with another vehicle while speeding down a freeway. The system is also able to detect an emergency condition 803 (by detecting an impact or the deployment of air bags for example) and automatically shut down or deactivate the limit function 805 so as not to interfere with the opening of any door after an accident. In that situation for example, if the limit function is deactivated by disengaging the limit motor, then the limit motor will automatically cause the limit element 511 to retract to its full open position as shown in FIG. 5. The limit motor may also be simply uncoupled so that any movement of the position element 503 will meet no resistance from the limit element 511 when the door is mechanically opened in an emergency situation.

If there is no emergency condition 803, the distance to the detected obstacle is measured 807 by the distance measuring sensors and that value is compared with a maximum opening distance 809. If the obstruction is within range 811 of the maximum opening, for example, an allowable opening is calculated 813. The allowable opening allows the door to open as wide as possible without contacting the detected obstruction. Signals are then sent to the limit motor to set the limit element for the allowable opening 815 and video and/or audio alarms and/or other messages are executed 817.

The method and apparatus of the present invention has been described in connection with a preferred embodiment as disclosed herein. The disclosed methodology may be implemented in a wide range of sequences to accomplish the desired results as herein illustrated. Although an embodiment of the present invention has been shown and described in detail herein, along with certain variants thereof, many other varied embodiments that incorporate the teachings of the invention may be easily constructed by those skilled in the art, and even included or integrated into a processor or CPU or other larger system integrated circuit or chip. The disclosed methodology may also be implemented solely or partially in program code stored on a CD, disk or diskette (portable or fixed), or other memory device, from which it may be loaded into memory and executed to achieve the beneficial results as described herein. Accordingly, the present invention is not intended to be limited to the specific form set forth herein, but on the contrary, it is intended to cover such alternatives, modifications, and equivalents, as can be reasonably included within the spirit and scope of the invention.

1. A method for controlling a limit to which a door may be opened, said method comprising:
determining an obstacle distance, said obstacle distance being representative of a distance between said door and an obstacle in a door opening path of said door;
providing a limit signal related to said obstacle distance; and
applying said limit signal to a door opening limit apparatus to effectively set an allowable limit to which said door can be opened, said allowable limit being less than said obstacle distance.

2. The method as set forth in claim 1 and further including:
selectively enabling an override of said allowable limit by an exertion of additional force to open said door farther after said door has been opened to said allowable limit.

3. The method as set forth in claim 1 wherein said door is a swingable door, and said setting of said allowable limit is implemented using a blocking device for physically preventing opening of said swingable door beyond said allowable limit.

4. The method as set forth in claim 3 wherein said limit signal is applied to a limit motor, said limit motor being operable in response to said limit signal to position a limit element effective to prevent opening of said swingable door beyond said allowable limit.

5. The method as set forth in claim 4 and further including means for causing linear movement of a door position element in response to a rotational movement of said swingable door, said allowable limit being reached when said door position element abuts said limit element during an opening of said swingable door.

6. The method as set forth in claim 1 wherein said determining is accomplished using a distance measuring device.

7. The method as set forth in claim 6 wherein said distance measuring device includes a radar system.

8. The method as set forth in claim 6 wherein said distance measuring device includes a sonar system.

9. The method as set forth in claim 6 wherein said method is implemented in a movable vehicle having a plurality of swingable doors, said distance measuring device being installed in at least one of said swingable doors.

10. The method as set forth in claim 6 wherein said movable vehicle is a motor vehicle, said motor vehicle further including processing means for processing said limit signal.

11. The method as set forth in claim 10 wherein said motor vehicle further includes alarm means for providing a perceivable alarm signal when an obstacle has been detected in said door opening path of said one of said swingable doors.

12. The method as set forth in claim 11 wherein said perceivable alarm signal is an audio signal.

13. The method as set forth in claim 11 and further including a display device, said perceivable alarm signal being a message display presented on said display device.

14. The method as set forth in claim 1 and further including:
terminating said method when an emergency condition is detected.

15. A storage medium including machine readable coded indicia, said storage medium being selectively coupled to a reading device, said reading device being selectively coupled to processing circuitry within a computer system, said reading device being selectively operable to read said machine readable coded indicia and provide program signals representative thereof, said program signals being selectively operable for controlling a limit to which a door may be opened by effecting the steps of:
determining an obstacle distance, said obstacle distance being representative of a distance between said door and an obstacle in a door opening path of said door;
providing a limit signal related to said obstacle distance; and
applying said limit signal to a door opening limit apparatus to effectively set an allowable limit to which said door can be opened, said allowable limit being less than said obstacle distance.

16. The medium as set forth in claim 15 and further including:
selectively enabling an override of said allowable limit by an exertion of additional force to open said door farther after said door has been opened to said allowable limit.

17. The medium as set forth in claim 15 wherein said door is a swingable door, said setting of said allowable limit being implemented using a blocking device for physically preventing opening of said swingable door beyond said allowable limit.

18. The medium as set forth in claim 17 wherein said limit signal is applied to a limit motor, said limit motor being operable in response to said limit signal to position a limit element effective to prevent opening of said swingable door beyond said allowable limit.

19. The medium as set forth in claim 18 and further including means for causing linear movement of a door position element in response to a rotational movement of said swingable door, said allowable limit being reached when said door position element abuts said limit element during an opening of said swingable door.

20. The medium as set forth in claim 15 wherein said determining is accomplished using a distance measuring device.

21. The method as set forth in claim 15 wherein said distance measuring device includes a radar system.

22. The method as set forth in claim 15 wherein said distance measuring device includes a sonar system.

23. The medium as set forth in claim 15 wherein said reading device is installed in a movable vehicle, said movable vehicle having a plurality of swingable doors, said radar device being installed in at least one of said swingable doors.

24. The medium as set forth in claim 21 wherein said movable vehicle is a motor vehicle, said motor vehicle further including processing means for processing said limit signal.

25. The medium as set forth in claim 24 wherein said motor vehicle further includes alarm means for providing a perceivable alarm signal when an obstacle has been detected in said door opening path of said one of said swingable doors.

26. The medium as set forth in claim 25 wherein said perceivable alarm signal is an audio signal.

27. The medium as set forth in claim 25 and further including a display device, said perceivable alarm signal being a message display presented on said display device.

28. The medium as set forth in claim 15 and further including:
terminating said method when an emergency condition is detected.

29. A system for controlling a limit to which a door may be opened, said system comprising:
a system bus;
a CPU device connected to said system bus;
a display device connected to said system bus;
memory means connected to said system bus; and
measuring means for determining an obstacle distance, said obstacle distance being representative of a distance between said door and an obstacle in a door opening path of said door, said measuring means being operable for providing a limit signal related to said obstacle distance; and
door opening limit apparatus arranged to receive said limit signal and effectively set an allowable limit to which said door can be opened, said allowable limit being less than said obstacle distance.

30. A method for providing a perceivable indication to occupants of a vehicle when an obstacle is present in a door opening path of said vehicle, said method comprising:
determining an obstacle distance, said obstacle distance being representative of a distance between said obstacle and a door of said vehicle; and
providing a perceivable indication to one or more occupants of said vehicle, said perceivable indication being related to said obstacle distance.
